(19) United States
(12) Patent Application Publication
(10) Pub. No.: US 2007/0008870 A1
(43) Pub. Date: Jan. 11, 2007

(54) Customizable electronic presentation medium

(76) Inventor: Jedediah M. Feller, Las Vegas, NV (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/484,002

(22) Filed: Jul. 10, 2006

Related U.S. Application Data
(60) Provisional application No. 60/697,568, filed on Jul. 8, 2005.

(51) Int. Cl. G11B 7/24

(52) U.S. Cl. 369/275.2

(57) ABSTRACT

An information recording and playback medium that is compatible with DVD AND/OR CD formats that has both read-only regions and also readable, writable and rewritable regions, and a method for recording and using such a medium, is disclosed.

### CROSS-REFERENCE TO RELATED APPLICATION

This application claims priority of U.S. provisional patent application, Ser. No. 60/697,568, filed Jul. 8, 2005.

### FEDERALLY SPONSORED RESEARCH OR DEVELOPMENT

Not Applicable.

### TECHNICAL FIELD

This invention generally relates to an information writing and reading medium that is compatible with DVD, CD, USB Flash Drive, SD™, CompactFlash®, and/or other digital electronic media storage formats (electronic media). This invention also relates to an information writing and reading medium that has portions that are read-only by a user and has portions that are writable or recordable by the user.

### BACKGROUND OF THE INVENTION

Electronic media is typically used to store information that will be read on playback devices, such as DVD players, CD players, and/or other digital electronic media players. The electronic media is used to store various types of information, such as video, music or computer data. The electronic media can be in a format where the electronic media contains read-only information and the end user may only read the information contained on the electronic media. The electronic media can also be in a format where information can be written and played back by the end user over and over again. A format does not currently exist where the electronic media has a read-only region that refers to writable regions on the same electronic media. These separate regions can be used to provide an intermediate user with read-only information that can be customized by the intermediate user with supplemental information that can be accessed and played back by an end user such that the end user has an experience that seamlessly blends the read-only information and the customized information into one presentation.

The present invention is provided to address these and other issues.

### DETAILED DESCRIPTION OF THE INVENTION

While this invention is susceptible of embodiment in many different forms, there will be described herein in detail, specific embodiments thereof with the understanding that the present disclosure is to be considered as an exemplification of the principles of the invention and is not intended to limit the invention to the specific embodiments illustrated.

Some types of electronic media are typically used for storing data that is read by the end user, where there is no need for the end user to write any data back to the disc.

Some other types of electronic media are typically used for writing and reading data. These types of electronic media can be written and rewritten several times over.

The invention, as illustrated herein as various embodiments, includes a type of electronic media that has regions that are for reading only and has regions that are for reading as well as writing and rewriting, as further elaborated below.

The invention can be used to provide users with read-only information that can be supplemented with information from an intermediate user.

The read-only information can be, but is not limited to, video footage or a catalog of products or services. The read-only information would point to areas on the media where further information is to be subsequently added.

The writable portion is meant to be supplemented with an intermediate user's own contributions, such as photographs, addresses or other personaucustomizable information.

The entire medium is then meant to be provided to an end user who will only be able to read the electronic media, yet be able to access both the read-only information that is supplemented with the customized information, in such a manner that the end user sees a seamless presentation that appears to have been produced entirely by the intermediate user.

The separate read-only and rewritable portions of the disc may be in separate areas of the electronic media. Additionally or alternatively, read-only and rewritable areas of the electronic media may alternate throughout contiguous portions of the disc.

The invention can be susceptible to embody one or more types of data and recording/playback formats, and/or other distinguishing or differentiating features. One of the differentiating features of the invention is that the types of information that can be part of the read-only portion and the types of information that can be part of the rewritable portion can vary considerably. For example, the intermediate user could simply add the name of a company and its address to a pre-existing read-only catalog of products in order to provide potential customers (end users) with a selection of products for which the intermediate user is a distributor.

As another example, a content providing company may provide generic information on the media, in read-only format, about professional services, such as generic information generally applicable to orthodontists and the orthodontic profession and such media would be provided to several orthodontists. An individual one of the orthodontists in turn can then customize the media to a first layer, through data entry or through referencing a specific file, adding generic data specific to the particular orthodontist to the writable portion of the electronic media, such as photographs of the orthodontist's office and information about the orthodontist's practice for the orthodontist's patients. Subsequently, the orthodontist can further customize individual ones of the media to a second layer by adding patient specific data to the writable portion of a specific one of the electronic media, such as information regarding the orthodontist's patient specific diagnosis and recommended treatment, to provide a customized presentation for each patient (end user). The patient specific data can be in the forms of text, audio and/or video. The read-only information includes information to guide one in the subsequent customization.

Similarly such a presentation medium could be used by real-estate agents where generic information about real-estate would be placed on the media in read-only format, and both generic information about a particular real-estate agent could be added as well as specific information for a particular potential buyer, such as information about houses visited by the potential purchaser.

The electronic media can be easily changed, mixed, matched and replaced with one or more types of information depending upon the intermediate user's preference. Additionally or alternatively, several intermediate users will be able to add their own information to the electronic media. The last intermediate user will have the ability to make the information already placed on the electronic media to be read only, so that the end user receives a read only electronic media that cannot be modified any further by the end user.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. An electronic media storage device comprising:
a read only portion storing read only content;
a writable portion;
means for storing electronic media;
means for a content provider to write read only content to the read only portion;
means for an intermediate user to write writable content to the writable portion;
means for referencing both the read only content and the writable content; and
means for making the writable content added by the intermediate user to be read only by an end user.

2. A method of permitting a presenter to make a customized presentation about a topic to a presentee, the method comprising:
providing information on a plurality of electronic mediums in read-only format, the information including generic information about the topic;
customizing a first sub-set of the plurality of electronic mediums to a first layer with information generic to the presenter; and
customizing a sub-set of the first sub-set to a second layer with information generally specific to the presentee.

3. The method of claim 2, wherein the presenter is a professional within a profession.

4. The method of claim 3, wherein the professional is a medical professional.

5. The method of claim 4 wherein the medical professional is an orthodontist.

6. The method of claim 4 wherein the information generally specific to the presentee includes diagnostic and recommended treatment information regarding a particular patient.

7. The method of claim 3 wherein the professional is a real-estate agent.

8. The method of claim 2 wherein the information stored in read-only format includes instructions for the customizing to the first and second layers.
